(19) United States
(12) Patent Application Publication
(10) Pub. No.: US 2004/0181984 A1
(43) Pub. Date: Sep. 23, 2004

(54) Shadow man

(76) Inventor: Michael Brozyna, St. Louis, MO (US)

Correspondence Address: Michael Brozyna, P.O. Box 410992, St. Louis, MO, 63141, US

(21) Appl. No.: 10/389,586

(22) Filed: Mar. 17, 2003

(51) Int. Cl. G09F 1/08

(52) U.S. Cl. 40/538; 40/612

(57) ABSTRACT

This invention takes the figure in the road sign warning of pedesrians and makes an enlarged solid rendition of the sign symbol that can be placed anywhere and can be of varying sizes. Instead of a frequently ignored warning sign, the automobile driver's attention will be drawn to the figures as a warning of pedestrian presence.

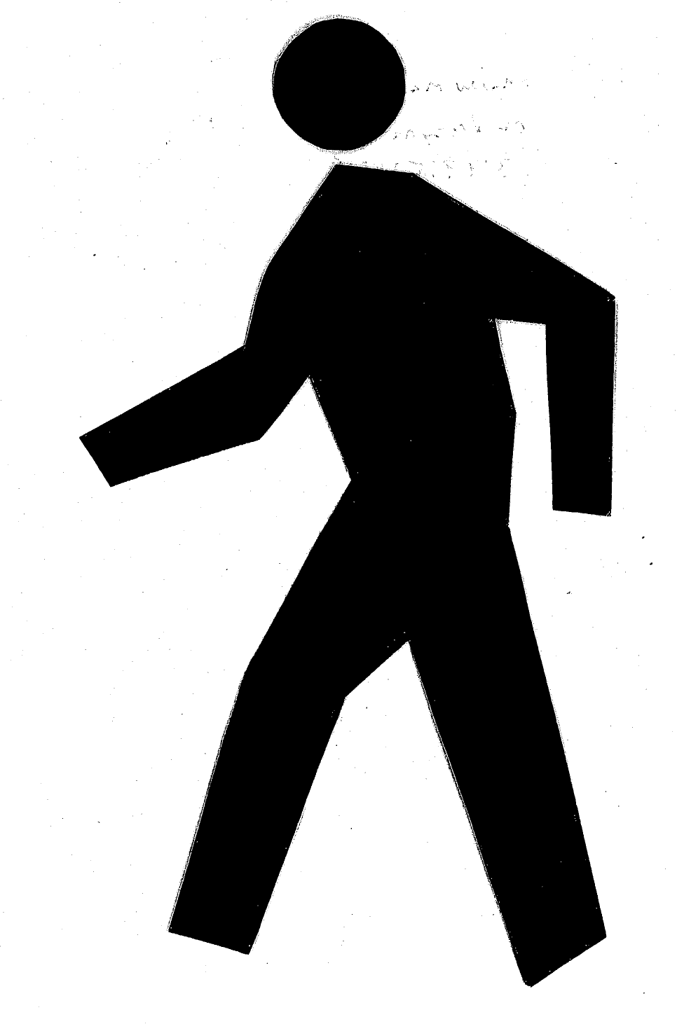

### CROSS REFERENCE TO RELATED APPLICATIONS

None

### STATEMENT REGARDING FEDERALLY SPONSORED RESEARCH OR DEVELOPMENT

None

### BACKGROUND OF INVENTION

This invention pertains to Safety Markers/Safety Products G-009. This invention is an improvement over the standard traffic sign warning of pedestrians or pedestrian crossings. These signs are all two dimensional and only placed at prescribed locations.

### BRIEF SUMMARY OF INVENTION

The current system of road signs to warn of pedestrians may not perform their intended function due to their placement rules. This invention takes the figure in the road sign and makes an enlarged solid rendition of the sign symbol that can be placed anywhere and can be of varying sizes. Instead of a frequently ignored warning sign, the automobile driver's attention will be drawn to the figure(s) as a warning of pedestrian presence. Since it is portable and its positioning is not governed by regulation, it can be quickly located anywhere temporary pedestrian activity may occur.

### BRIEF DESCRIPTION OF SEVERAL VIEWS OF THE DRAWING

One view is provided which depicts the general outline of the “shadowman” figure. The prototype “shadowman” is approximately ½ inches thick and four feet tall, giving it three-dimensional status.

### DETAILED DESCRIPTION OF THE INVENTION

The current system of road signs to warn of pedestrians may not perform their intended function due to their ubiquity yet strict placement rules. This invention takes the figure in the road sign warning of pedestrians and makes an enlarged solid rendition of the sign symbol that can be placed anywhere and can be of varying sizes. The figure is designed for use by non-government entities and for placement wherever the owner see fit. Because a method to anchor the “shadowman” is not prescribed, it can be fastened to a post, or fastened to stakes on each leg for portability. Since it is portable and its positioning is not governed by regulation, it can be quickly located anywhere temporary pedestrian activity may occur. The “shadowman” is made of material at least ¼″ inches thick and rigid enough to withstand wind without bending. Wood, metal and rigid plastic would all be suitable materials for construction. The material and coatings are made of water-resistant materials so that constant exposure to the elements will not impair its functionality. While the prototype color is black, there may be circumstances where a more visible color will be used, i.e. safety orange or safety yellow.

What I claim as my invention is:

1. Any three dimensional “shadowman” figure that is designed to stand upright having the same general shape or outline as depicted in the attached drawing.

2. According to claim 1, any size of “shadowman” is covered.

3. According to claim 1, construction of a “shadowman” out of any material is covered (i.e. wood, metal, plastic, cardboard, ceramic).

4. According to claim 1, any color of “shadowman” is covered.
